(19) United States
(12) Patent Application Publication
(10) Pub. No.: US 2010/0333071 A1
(43) Pub. Date: Dec. 30, 2010

(54) Time Based Context Sampling of Trace Data with Support for Multiple Virtual Machines

(75) Inventors: Kean G. Kuiper, Round Rock, TX (US); Frank E. Levine, Austin, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/494,469

(22) Filed: Jun. 30, 2009

(51) Int. Cl. G06F 9/44

(52) U.S. Cl. 717/128; 717/130

(57) ABSTRACT

Mechanisms for time based context sampling of trace data with support for multiple virtual machines are provided. In response to the occurrence of an event, a plurality of sampling threads associated with a plurality of executing threads executing on processors of a data processing system are awakened. For each sampling thread, an execution state of a corresponding executing thread is determined with regard to one or more virtual machines of interest. For each sampling thread, based on the execution state of the corresponding executing thread, a determination is made whether to retrieve trace information from a virtual machine of interest associated with the corresponding executing thread. For each sampling thread, in response to a determination that trace information is to be retrieved from a virtual machine of interest associated with the corresponding executing thread, the trace information is retrieved from the virtual machine.

### BACKGROUND

The present application relates generally to an improved data processing apparatus and method and more specifically to mechanisms for time based context sampling of trace data with support for multiple virtual machines.

In analyzing and enhancing performance of a data processing system and the applications executing within the data processing system, it is helpful to know which software modules within a data processing system are using system resources. Effective management and enhancement of data processing systems requires knowing how and when various system resources are being used. Performance tools are used to monitor and examine a data processing system to determine resource consumption as various software applications are executing within the data processing system. For example, a performance tool may identify the most frequently executed modules and instructions in a data processing system, or may identify those modules which allocate the largest amount of memory or perform the most I/O requests. Hardware performance tools may be built into the system or added at a later point in time.

One known software performance tool is a trace tool. A trace tool may use more than one technique to provide trace information that indicates execution flows for an executing program. One technique keeps track of particular sequences of instructions by logging certain events as they occur, so-called event-based profiling technique. For example, a trace tool may log every entry into, and every exit from, a module, subroutine, method, function, or system component. Alternately, a trace tool may log the requester and the amounts of memory allocated for each memory allocation request. Typically, a time-stamped record is produced for each such event. Corresponding pairs of records similar to entry-exit records also are used to trace execution of arbitrary code segments, starting and completing I/O or data transmission, and for many other events of interest.

In order to improve performance of code generated by various families of computers, it is often necessary to determine where time is being spent by the processor in executing code, such efforts being commonly known in the computer processing arts as locating “hot spots.” Ideally, one would like to isolate such hot spots at the instruction and/or source line of code level in order to focus attention on areas which might benefit most from improvements to the code.

Another trace technique involves periodically sampling a program's execution flows to identify certain locations in the program in which the program appears to spend large amounts of time. This technique is based on the idea of periodically interrupting the application or data processing system execution at regular intervals, so-called sample-based profiling. At each interruption, information is recorded for a predetermined length of time or for a predetermined number of events of interest. For example, the program counter of the currently executing thread, which is an executable portion of the larger program being profiled, may be recorded at each interval. These values may be resolved against a load map and symbol table information for the data processing system at post-processing time and a profile of where the time is being spent may be obtained from this analysis.

Known sampling trace techniques are limited to performing traces on a single execution environment at a time. That is, the sampling of the program's execution flow is performed with regard to a single operating system and virtual machine execution environment. In recent years, however, application middleware has increasingly needed to use multiple virtual machines to support various applications. Using known sampling trace techniques, each individual virtual machine execution environment must be individually sampled one at a time in a sequential fashion. This leads to increased trace and analysis time as well as trace information that may not be as accurate as otherwise could be obtained.

### SUMMARY

In one illustrative embodiment, a method, in a data processing system, is provided for performing time-based context sampling for profiling an execution of computer code in the data processing system. The method comprises, in response to the occurrence of an event, waking a plurality of sampling threads associated with a plurality of executing threads executing on processors of the data processing system. The method further comprises determining, for each sampling thread, an execution state of a corresponding executing thread with regard to one or more virtual machines of interest. Moreover, the method comprises determining, for each sampling thread, based on the execution state of the corresponding executing thread, whether to retrieve trace information from a virtual machine of interest associated with the corresponding executing thread. Furthermore, the method comprises, for each sampling thread, in response to a determination that trace information is to be retrieved from a virtual machine of interest associated with the corresponding executing thread, retrieving the trace information from the virtual machine.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is pictorial representation of a data processing system in which illustrative embodiments may be implemented;

FIG. 2 is an example block diagram of elements of a data processing system in which aspects of the illustrative embodiments may be implemented;

FIG. 3 is an example diagram illustrating components used to profile an execution of a computer program in accordance with one illustrative embodiment;

FIG. 4 is a diagram illustrating components used in obtaining call stack information in accordance with one illustrative embodiment;

FIG. 5 is a diagram of a call tree in accordance with one illustrative embodiment;

FIG. 6 is a diagram illustrating information in a node in accordance with one illustrative embodiment;

FIG. 7 is a flowchart outlining an example process for obtaining call stack information for a target thread in accordance with one illustrative embodiment;

FIG. 8 is a flowchart outlining an example process in a sampling thread for collecting call stack information in accordance with one illustrative embodiment;

FIG. 9 is a flowchart outlining an example process for notifying sampling threads on processors in response to receiving an interrupt in accordance with one illustrative embodiment;

FIG. 10 is a flowchart outlining an example process for a sampling thread in accordance with an illustrative embodiment;

FIG. 11 is an example block diagram of a system for performing profiling of a computer program with regard to multiple threads executed by multiple processors in conjunction with multiple virtual machines in accordance with one illustrative embodiment; and

FIG. 12 is a flowchart outlining an example operation of sampling thread in accordance with an illustrative embodiment in which multiple threads of multiple processors and multiple virtual machines are profiled.

### DETAILED DESCRIPTION

The illustrative embodiments provide mechanism for providing time based context sampling of trace data with multiple virtual machine support. With the mechanisms of the illustrative embodiments, multiple virtual machine execution environments may be sampled concurrently using a plurality of sampler threads associated with the various processors that access the various virtual machines. Moreover, a mechanism for waking up each of these sampler threads and for determining what, if any, trace data or information is to be obtained, is provided. Thus, each time there is an interrupt or other event causing a call to a device driver requiring sampling of trace information, each sampling thread in the profiler is awoken and, depending on the state of the execution thread at the time that the sampling thread is awoken, trace information is retrieved and stored in a trace data file for the particular thread.

The determination as to what and if any trace data is to be obtained may be performed based upon where the execution of a corresponding execution thread in the execution environment is at the time that the sampler thread is awoken. For example, if the sampler thread is awoken at a time where the execution thread is presently accessing the virtual machine, then call stack information may be gathered. If the sampler thread is awoken at a time where the execution thread is in the middle of performing a garbage collection operation, call stack information may not be gathered. Various conditions may be established for defining when and what trace information is to be gathered based on the particular execution state of the execution thread.

Moreover, various counters may be provided for use in obtaining statistics about the use of the sampler threads in conjunction with execution threads and the virtual machines. These counters may be associated with particular conditions of the state of execution of the execution thread. Corresponding counters may be incremented each time a sampler thread is awoken and the state of its corresponding execution thread corresponds to the conditions associated with the counter. These counter values may be sampled as well and stored as part of the trace data file for an execution thread. This information, along with the other trace information, may be used to generate a report that details the execution state of a computer program in the execution environment(s) of the data processing system at various time points during the execution. This information can be used to identify a distribution of processing resources during the execution of the computer program.

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, radio frequency (RF), etc.

Computer program code for carrying out operations of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In addition, the program code may be embodied on a computer readable storage medium on the server or the remote computer and downloaded over a network to a computer readable storage medium of the remote computer or the users' computer for storage and/or execution. Moreover, any of the computing systems or data processing systems may store the program code in a computer readable storage medium after having downloaded the program code over a network from a remote computing system or data processing system.

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

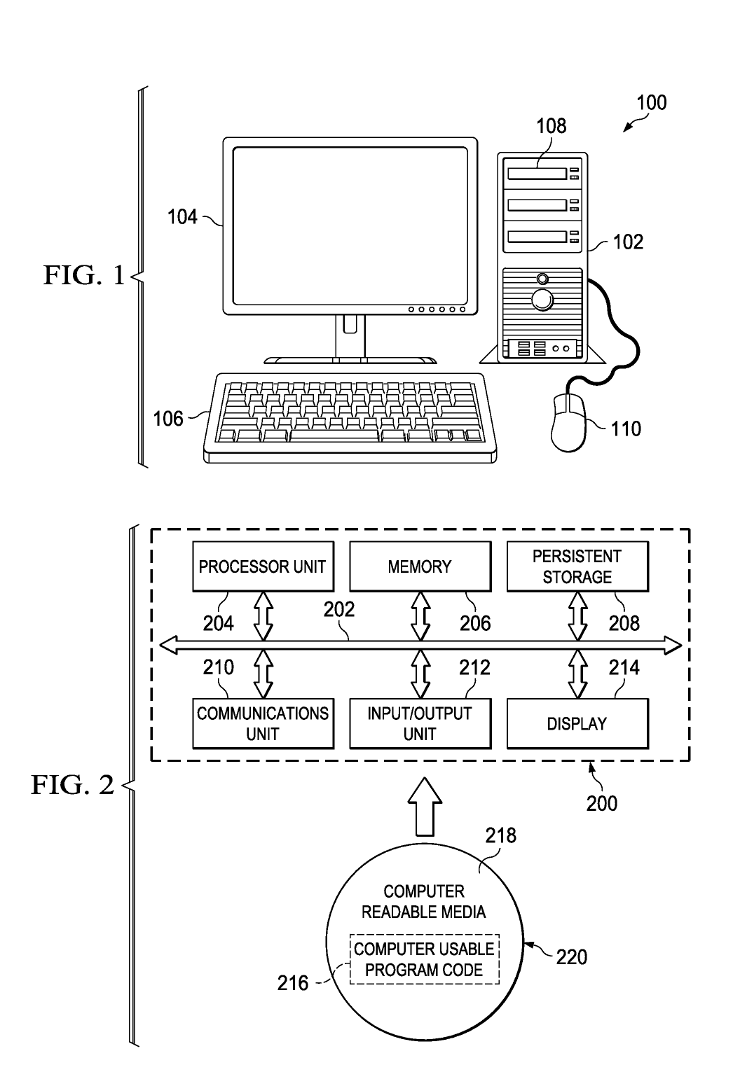

With reference now to the figures, and in particular with reference to FIG. 1, a pictorial representation of a data processing system is shown in which illustrative embodiments may be implemented. As shown in FIG. 1, computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices could include, for example, a joystick, a touchpad, a touch screen, a trackball, and a microphone.

Computer 100 may be any suitable computer, such as an IBM™ eServer™ computer or IntelliStation™ computer, which are products of International Business Machines Corporation, located in Armonk, N.Y., or any other type of computing device. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

Turning now to FIG. 2, a diagram of a data processing system is depicted in accordance with an illustrative embodiment of the present invention. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main, or control, processor is present along with secondary processors, or co-processors, that use the same or a different instruction set from that of the main processor, on a single chip. One example of a heterogeneous processor system that may be used to implement the mechanisms of the illustrative embodiments is the Cell Broadband Engine™ available from International Business Machines Corporation of Armonk, N.Y. As another illustrative example, processor unit 204 may be a symmetric multiprocessor (SMP) system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as computer usable program code or computer readable program code that may be read and executed by a processor in processor unit 204. The computer readable program code may be embodied on different physical or tangible computer readable media, such as memory 206 or persistent storage 208.

Computer usable program code 216 is located in a functional form on computer readable media 218 and may be loaded onto, or transferred to, data processing system 200. Computer usable program code 216 and computer readable media 218 form computer program product 220 in these examples. In one example, computer readable media 218 may be, for example, an optical or magnetic disc that is inserted or placed into a drive or other device that is part of persistent storage 208 for transfer onto a storage device, such as a hard drive that is part of persistent storage 208. Computer readable media 218 also may take the form of a persistent storage, such as a hard drive or a flash memory that is connected to data processing system 200.

Alternatively, computer usable program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also make take the form of non-tangible media, such as communications links or wireless transmission containing the computer readable program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

The depicted examples in FIGS. 1 and 2 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1 or data processing system 200 shown in FIG. 2, or other types of data processing systems and/or computing devices as will be readily apparent to those of ordinary skill in the art in view of the present description.

The illustrative embodiments provide a computer implemented method, apparatus, and computer usable program code for sampling call stack information from multiple virtual machines of one or more processors concurrently in an efficient manner by causing samples to be taken from each virtual machine that was interrupted at the time of the sampling. Moreover, statistical information may be collected, such as by using various counters or the like in a profiler mechanism, to provide statistical information regarding the time spent by threads in various areas of the execution environment of the data processing system.

While the mechanisms of the illustrative embodiments operate to obtain samples of call stack information for a plurality of processors and multiple virtual machines concurrently, it is first best to understand how such sampling of call stack information can be performed with regard to a one or more processors and a single virtual machine. Thus, this description will first provide an example of how call stack information may be sampled with regard to a single virtual machine and threads executing on one or more processors and will then show how this may be extended to the concurrent sampling of call stack information for a plurality of processors and multiple virtual machines in accordance with the illustrative embodiments.

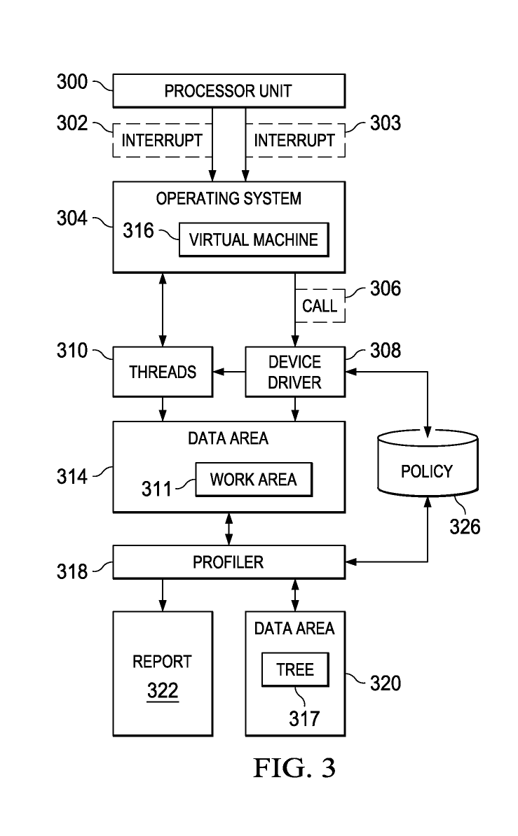

FIG. 3 is an example diagram illustrating components used to identify states during processing in accordance with an illustrative embodiment. In this depicted example, the components are examples of hardware and software components found in a data processing system, such as data processing system 200 in FIG. 2.

In the depicted example, processor unit 300 may generate interrupt 302 that is sent to the operating system 304 and another processor in processor unit 300 may generate interrupt 303 which is also sent the operating system 304. These interrupts may result in a call 306 of a routine or function being generated by the operating system 304 and sent to the device driver 308. Various mechanisms exist to allow operating systems, such as operating system 304, to generate calls, such as call 306, based on interrupts from processors. Examples of such mechanisms include registering an interrupt handler, i.e. a portion of computer code designed to handle certain interrupt conditions, with operating system 304 to be notified when interrupts 302 and/or 303 occur, or having device driver 308 hook (directly handle) interrupt vectors so that the device driver 308 obtains control when either interrupt 302 or 303 occurs.

When device driver 308 receives call 306 and determines that a sample should be taken, device driver 308 places information, such as the thread identifier (TID) of the thread whose call stack is to be sampled, in work area 311 for a chosen sampling thread (not shown). That is, there may be a separate work area 311 for each sampling thread of the profiler 318 with information being placed in the appropriate work area 311 for the appropriate sampling thread of the profiler 318 that is to be used to sample trace data for profiling the execution of computer code in the execution environment. The device driver 308 further sends a signal to a corresponding sampling thread of the profiler 318 instructing the sampling thread to collect call stack information for a thread of interest within threads 310. In these examples, the thread of interest is the thread that was executing on the processor of the processing unit 300 that generated the interrupt 302 or 303 that resulted in the operating system call 306 to the device driver 308.

The sampler thread that was signaled by the device driver 308 checks its corresponding work area 311 within data area 314 to determine what work the particular sampling thread should perform. In these examples, work area 311 may identify the work required to obtain call stack information for the interrupted thread. Alternatively, depending upon the particular information placed in the work area 311 by the device driver 308, other operations could be performed by the sample thread, such as incrementing counters, reading counter values, generating statistics, or the like.

In one illustrative embodiment, a sampling thread within threads 310 performs the work to collect call stack information from virtual machine 316 which, in one illustrative embodiment, is a Java™ virtual machine (JVM). While the illustrative embodiments will be described in the context of obtaining call stack information from a JVM, the illustrative embodiments are not limited to such. Rather, the collection of call stack information may be performed with respect to other virtual machines or other applications not in a virtual machine, depending on the particular implementation.

Profiler 318, in one illustrative embodiment, is a time based context sampling profiler application. The selected sampling thread in profiler 318 uses the information placed in work area 311 to determine the thread whose call stack is to be obtained. For example, a process identifier (PID) and a thread identifier (TID) for the interrupted thread may be written to the work area 311 to thereby identify to the sampling thread which execution thread of which process is the subject of the sampling. The call stack information for the execution thread identified by the TID may be obtained and processed by the sampling thread to create a call tree 317 in data area 320, which is allocated and maintained by profiler 318. The call tree 317 contains call stack information and may also include additional information about the leaf nodes, which are the current routines being executed at the time of the interrupt and sampling of the call stack.

In the case of an interrupt in these illustrative examples, the interrupt handler may make a determination that a thread of interest was interrupted, i.e. was executing and its execution was branched to the interrupt handler, and initiate a Deferred Procedure Call (DPC), or a second level interrupt handler to signal profiler 318. In one embodiment, an interrupt is generated periodically based on some criteria, such as, policy 326. In these examples, triggering the collection of call stack information may be performed each time a thread within a specified process is interrupted. Of course, other events also may be used to initiate collection of the information. For example, the information may be generated periodically in response to a hardware counter overflow.

Profiler 318 may generate report 322 based on the call stack information collected over some period of time. The time based sampling provides an accurate estimate of the cycles spent in the routine for which the code was executing at the time the sample was taken, and also for the path taken to get to the code where the sample was taken. The reports based on the information collected produce a reasonably accurate picture of time spent in each routine as well as the accumulated time in the routines called by the selected routine.

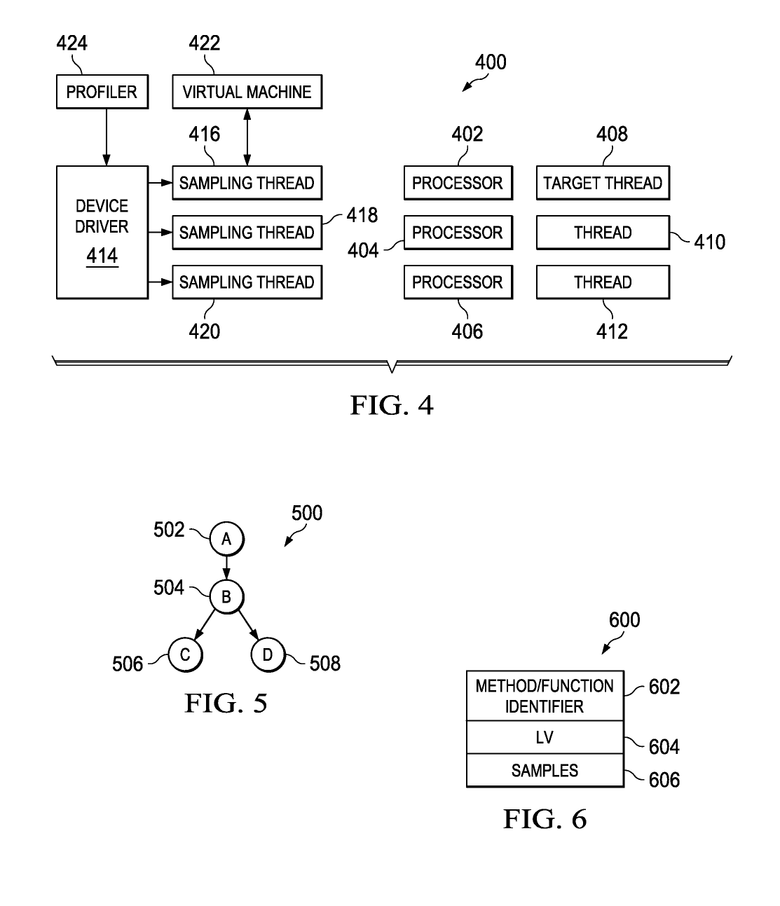

FIG. 4 is an example diagram illustrating components used in obtaining call stack information in accordance with one illustrative embodiment. In this example, data processing system 400 includes processors 402, 404, and 406. These processors are examples of processors that may be found in processor unit 300 in FIG. 3, for example. During execution, each of these processors 402, 404, and 406, may have threads executing on them. Alternatively, one or more processors may be in an idle state in which no threads are executing on the idle processors.

In the depicted example, when an interrupt occurs, target thread 408 is executing on processor 402, thread 410 is executing on processor 404, and thread 412 is executing on processor 406. For purposes of this example, target thread 408 is the thread interrupted on processor 402. For example, the execution of target thread 408 may be interrupted by a timer interrupt or hardware counter overflow, where the value of the counter is set to overflow after a specified number of events, e.g., after 100,000 instructions are completed.

When an interrupt is generated, device driver 414 sends a signal to sampling threads 416, 418, and 420. Each of these sampling threads is associated with one of the processors. Sampling thread 418 is associated with processor 404, sampling thread 420 is associated with processor 406, and sampling thread 416 is associated with processor 402. Device driver 414 awakens these sampling threads 416, 418, and 420 when a predetermined sampling criteria is met, e.g., the timer or counter overflow mentioned above. In these examples, device driver 414 is similar to device driver 308 in FIG. 3.

Sampling threads 418 and 420 are signaled and allowed to be active or executed without performing any work before signaling sampling thread 416. That is, sampling thread 416 is assigned work, which is a request to obtain call stack information for target thread 408, while no work is assigned to sampling threads 418 and 420 because threads 410 and 412 have not yet been interrupted. Sampling threads 418 and 420 are active such that processor 404 and processor 406 do not enter an idle state. In this manner, target thread 408 will not migrate from processor 402 to another processor because all of the processors are currently busy executing threads. By having processors 402, 404, and 406 in non-idle states, the movement of target thread 408 from processor 402 to another processor is avoided in these examples.

In the depicted example, sampling thread 416 is assigned work in the form of obtaining call stack information from virtual machine 422. Virtual machine 422 is similar to virtual machine 316 executing in operating system 304 in FIG. 3. The call stack information may be obtained by making appropriate calls to virtual machine 422 which, in this example, is a JVM. In the depicted example, the interface used to access the JVM is a Java Virtual Machine Tools Interface (JVMTI). This interface allows for the collection of call stack information. The call stacks may be, for example, standard trees containing usage counts for different threads or methods. The JVMTI is an interface that is available in Java 5 software development kit (SDK), version 1.5.0. The Java virtual machine profiling interface (JVMPI) is available in Java 2 platform, standard edition (J2SE) SDK version 1.4.2. These two interfaces allow processes or threads to obtain information from the JVM in the form of a tool interface to the JVM. Descriptions of these interfaces are available from Sun Microsystems, Inc. and thus, further explanation of these interfaces is not provided herein. Either interface, or any other interface to a JVM, may be used to obtain call stack information for one or more threads in accordance with the illustrative embodiments.

The sampling thread 416 provides the call stack information to profiler 424 for processing. The profiler 424 constructs a call tree from the call stack information obtained from the virtual machine 422 at the time of the sampling. The call tree may be constructed by analyzing the call stack information for method and/or function entries and exits identified in the call stack information. This call tree can be stored as tree 317 in data area 320 of FIG. 3, or as a separate file in a separate data area, by profiler 318 in FIG. 3.

FIG. 5 is an example diagram of a call tree that may be generated using the mechanisms of the illustrative embodiments. The call tree 500 is an example of a call tree similar to call tree 317 in FIG. 3, for example. Call tree 500 is created and modified by an application, such as profiler 318 in FIG. 3, based on call stack information gathered using one or more sampling threads. In the example call tree 500 shown in FIG. 5, the call tree 500 is composed of nodes 502, 504, 506, and 508 and arcs between nodes indicating which nodes call which other nodes in the call tree 500. In the depicted example, node 502 represents an entry into method A, node 504 represents an entry into method B, and nodes 506 and 508 represent entries into method C and D respectively.

Turning now to FIG. 6, a diagram illustrating information in a node of a call tree is depicted in accordance with one illustrative embodiment. Entry 600 is an example of information in a node, such as node 502 in FIG. 5, of a call tree, such as call tree 500, generated based on trace information obtained by sampling threads sampling a call stack of a virtual machine. In this example, entry 600 contains method/function identifier 602, tree level (LV) 604, and samples 606. Method/function identifier 602 contains, for example, the name of the method or function that the node represents. Tree level (LV) 604 identifies the hierarchical tree level of the particular node within the call tree. For example, with reference back to FIG. 5, if entry 600 is for node 502 in FIG. 5, tree level 604 would indicate that this node is a root node.

The nodes of the call tree may be used to generate a report, such as report 322 in FIG. 3, indicating the results of the sampling of the execution of a computer program using the threads 310 in FIG. 3 in the execution environment comprising the processor unit 300, operating system 304, virtual machine 316, etc. The report may be an analysis of the call tree and its nodes to identify, for example, areas where execution of a computer program spends a relatively large amount of time. The report may provide a mechanism for visualizing the manner by which the computer program executes within the execution environment. Report visualization mechanisms may include a flat profile for individual routines, i.e., the amount of time executed by a specific routine and the summary of time spent in all the routines that they called. Other reports may identify the callers of each routine and the routines called by the routine as well as a full call stack for identifying the paths to the routine and all of the routines it calls.

Returning to FIG. 3, when the sample threads of the profiler 318 are signaled, the corresponding sampler threads of the profiler 318 request that a call stack be retrieved for each thread of interest via the virtual machine interface, e.g., JVMTI and/or JVMPI. Each call stack that is retrieved is “walked,” or recorded into a process or virtual machine specific call tree. This is typically recorded by thread to avoid locking and to provide improved performance. After the retrieved call stack is walked into the tree, the metric, in this case, the count of samples, is added to the samples base in the leaf node. Each sample or change to metrics that is provided by the device driver 308 are added to a call tree's leaf node's base metrics. These metrics may include, for example, a count of samples of occurrences a specific call stack sequences. In other embodiments the call stack sequences may simply be recorded.

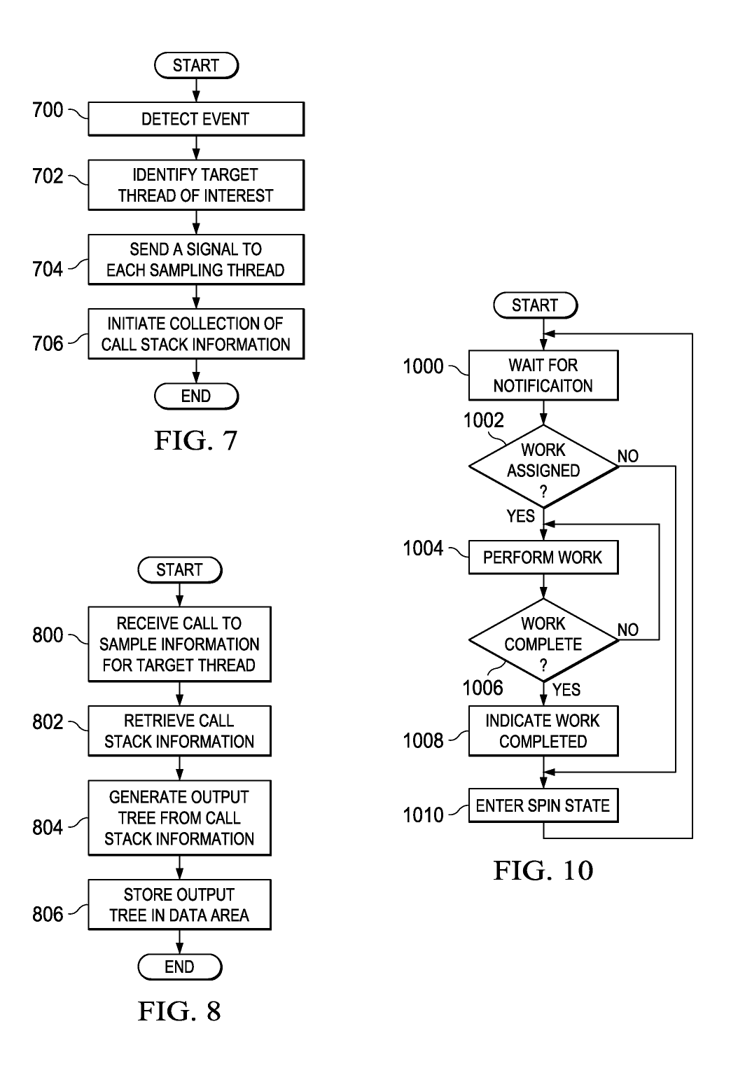

FIG. 7 is an example flowchart of a process for obtaining call stack information for a target thread in accordance with one illustrative embodiment. The process illustrated in FIG. 7 may be implemented in a software component, such as device driver 414 in FIG. 4, for example.

The process begins by detecting a monitored event (step 700). In one illustrative embodiment, this monitored event may be, for example, a call from the operating system indicating that an interrupt has occurred by a processor. A target thread, i.e. a thread that was executing when the monitored event occurred, is identified (step 702). Information is written to a work area for each of the sampling threads to identify the respective process and thread identifiers corresponding to the sampling threads of a profiler and thereafter, a signal is sent to each sampling thread (step 704).

The signal is sent to all the sampling threads in step 704 and not just the sampling thread associated with the processor on which the target thread of interest was executing when the event occurred. For those sampling threads that are not associated with the processor on which the target thread of interest was executing, these sampling threads enter a spin state, as will be described hereafter, and do not generate any call stack trace information for the particular sampling. The signaling of all of the sampling threads is performed to ensure that none of the processors are in an idle state. By preventing processors from entering or remaining in an idle state, migration or movement of the target thread is avoided in these illustrative embodiments.

Thereafter, a collection of call stack information is initiated for the target thread of interest (step 706) with the process terminating thereafter. As discussed above, the collection of call stack information may be performed using the JVMTI and/or JVMPI interfaces of a JVM, for example.

Turning next to FIG. 8, a flowchart of a process in a thread for generating a call tree in accordance with one illustrative embodiment is provided. The process illustrated in FIG. 8 may be implemented in a sampling thread, such as sampling thread 416 in FIG. 4, for example. Thus, the process shown in FIG. 8 may be performed in a profiler, such as profiler 318 in FIG. 3, using a sampling thread that collects call stack information from a virtual machine for a target thread of interest.

The process begins by receiving a notification to sample information for a target thread (step 800). For example, this notification may be the signaling from the device driver that the sampling thread is to collect call stack information. Thereafter, the call stack information is retrieved from the virtual machine, such as via a virtual machine interface, e.g., JVMTI and/or JVMPI(step 802). An output call tree is generated from the call stack information, such as by walking the call stack information and generating the nodes and arcs between nodes that comprise the call tree (step 804). Call tree 500 in FIG. 5 is an example of an output call tree that may be generated by the sampling thread.

Finally, the output call tree is stored in a data area (step 806) with the process terminating thereafter. In these examples, the call tree is stored in a data area, such as data area 314 in FIG. 3 and may be the basis for the generation of one or more reports.

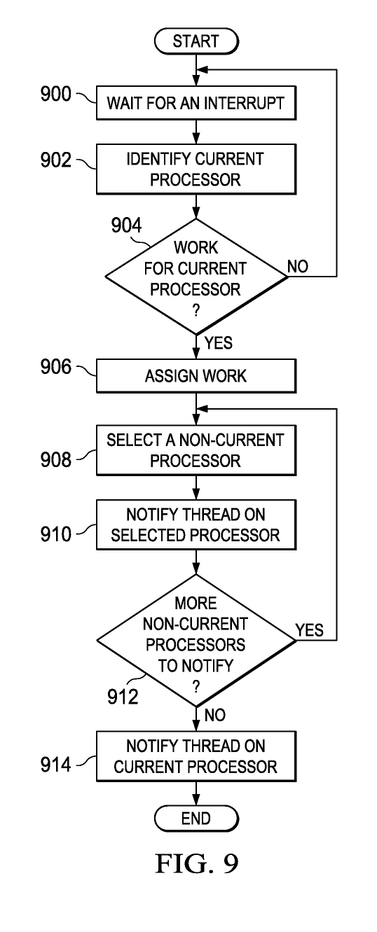

FIG. 9 is a flowchart of a process for notifying threads on processors in response to receiving an interrupt in accordance with one illustrative embodiment. The process illustrated in FIG. 9 may be implemented, for example, in a software component such as device driver 414 in FIG. 4.

As shown in FIG. 9, the process begins by waiting for an event, such as an interrupt (step 900). When the event occurs, such as an interrupt occurs, a current processor is identified (step 902). In this example, the current processor is the processor on which the interrupt was received. The target thread is the thread that was executing on the current processor at the time of the interrupt. The target thread is a thread of interest for which call stack information is desired.

A determination is made as to whether work is present for the current processor (step 904). Step 904 may be performed by the device driver using a policy, such as policy 326 in FIG. 3. Call stack information may not be desired every time an interrupt occurs. The “event” that triggers the collection of call stack information may be a combination of an occurrence of the interrupt and the presence of a condition. For example, call stack information may not be desired until some user state occurs, such as a specific user or type of user being logged into a data processing system. As another example, call stack information may not be desired until the user starts some process or initiates some action. If work is not present, the process returns to step 900 to wait for another interrupt.

If work is present for the current processor, the process assigns work (step 906). The work may be assigned by placing the work assignment in a work area, such as work area 311 in FIG. 3. In these examples, the work is assigned to a sampling thread that is associated with the processor on which the thread of interest was executing when the interrupt occurred. A non-current processor is selected (step 908) and the thread on the selected processor is notified (step 910). In step 910, a signal is sent to the sampling thread for the selected processor to wake that sampling thread.

Thereafter, a determination is made as to whether more non-current processors are present to notify (step 912). If additional non-current processors are present for notification, the process returns to step 908. Otherwise, the thread on the current processor is notified (step 914) with the process terminating thereafter. The sampling thread for the current processor is notified last in these examples, however the illustrative embodiments are not limited to such. Rather, the thread on the current processor may be notified first without departing from the spirit and scope of the illustrative embodiments.

With reference now to FIG. 10, a flowchart of a process for a sampling thread is depicted in accordance with one illustrative embodiment. The process illustrated in FIG. 10 may be implemented by a sampling thread, such as sampling thread 416, sampling thread 418, or sampling thread 420 in FIG. 4, in conjunction with a profiler application, such as profiler 318 in FIG. 3.

As shown in FIG. 10, the process begins by waiting for a notification (step 1000). When a notification is received, a determination is made as to whether work has been assigned to the sampling thread (step 1002). The identification of whether work has been assigned will be made by looking at a memory location or data area, such as work area 311 in FIG. 3, for example, and determining if there are process identifiers, thread identifiers, and other information indicating the types of work to be performed, e.g., the types of trace information to collect or the like. For purposes of the illustrative embodiments, the presence of a process identifier and thread identifier in the work area may in itself be an indication that call stack information is to be retrieved for that particular process identifier and thread identifier. In one illustrative embodiment, the work may be assigned in data area 314 in FIG. 3 to different sampling threads.

If work has not been assigned, the process continues at step 1010. On the other hand, if work has been assigned, the assigned work is performed (step 1004). In these examples, the work is to obtain call stack information for the target thread.

A determination is then made as to whether the work is complete (step 1006). If the work is not complete, the process returns to step 1004. Otherwise, if the work is complete, an indication that the work is completed is made (step 1008). This indication may be made in a work area, such as work area 311 in FIG. 3, for example. The indication allows other sampling threads to know that the call stack information has been collected.

For those threads who have completed their work, or for which work has not been assigned (step 1002), the process enters a spin state (step 1010) until all work being performed by all of the threads is completed. When the spin state completes, the process returns to step 1000 to wait for another notification. In performing step 1010, the sampling thread may execute a spin-wait loop. This type of loop is a short code segment that reads a memory location and then compares it to a particular value. If the content of the memory location is equal to this value, then the loop completes execution. In these examples, the memory location is the work area. The indication that work has been completed by the sampling thread is the particular value needed to stop the spin state in these examples. Otherwise, the memory location is re-read and a comparison is performed again. In these examples, the spin state terminates when an indication that the work has been completed occurs. This mechanism allows the sampling threads to continue to be active until the call stack information has been collected.

The above mechanisms allow the profiler to use one sampling thread at a time to collect call stack information for one executing thread at a time in association with a single virtual machine of an execution environment. Only the sampling thread associated with the processor that generated the interrupt is actually used at any one time to gather trace information, i.e. the sampling of the call stack. While the sampling thread corresponding to the interrupted processor is gathering call stack information, the other sampling threads may be awoken and placed in a spin state simply to avoid migration of threads while the call stack information is being gathered. However, no trace information is gathered with regard to these other sampling threads.

In a further illustrative embodiment, as mentioned above, the data processing system may comprise a plurality of virtual machines with threads on a plurality of processors accessing one or more of these virtual machines. In this further illustrative embodiment, each time an event occurs requiring a sampling of trace information, e.g., a sampling of the call stacks of one or more of the virtual machines, all of the sampling threads of all of the processors are awoken. A determination is made with regard to each sampling thread as to the execution state of their corresponding execution threads. This determination determines if the sampling thread is to gather trace information, is to be placed in a loop or spin state, or should simply update device driver sampling statistics information. In one embodiment, interrupts are generated on each processor and each interrupt handler either loops until all processors have interrupted, or deferred procedure calls (DPCs) or second level interrupt handlers are queued, and the DPCs or second level interrupt handlers loop until it is determined that the processor's DPC or second level handler is being executed. In an alternative embodiment, when a sampling interrupt occurs on one processor, an Inter-processor Interrupt (IPI) is generated to force an interrupt on the other processors. In any case, once it is determined that all processors are now ready to continue processing the sample, the logic makes a determination if any sampler thread needs to be posted to process a sample. If none of the sampler threads need to be posted to process a sample, then counts are updated.

For example, for each sampling thread, if the corresponding execution thread is presently executing in a virtual machine of interest, i.e. is accessing a virtual machine of interest, then trace information for that virtual machine and execution thread is gathered by the corresponding sampling thread. If the execution thread is not presently executing in a virtual machine of interest, but there are other sampling threads associated with execution threads executing in a virtual machine of interest, then the current sampling thread may be placed in a loop or spin state until the trace information is gathered by the other sampling threads. If neither of these conditions are present, then device driver sampling statistics, e.g., counter values, are simply updated. These device driver sampling statistics may be updated when the other conditions are detected as well.

For example, JVMs are registered for monitoring by a profiler attached to the JVM. When a profiler determines that a JVM should be monitored, it creates sampling threads, one for each process, and registers the JVM via interfaces supported by the device driver. When a sample is taken, the device driver rotates through each of the registered JVMs to update counts and determine if a notification of a specific sampler thread is needed. If any sampler thread needs to be notified, then it will notify one sampler thread per processor to either retrieve the call stack for the interrupted thread or to spin waiting till all the sampler threads have completed their work. The determination of completion by the sampling threads may be done by checking all sampler threads, i.e. all registered JVMs, for work in progress. Once it is determined that all sampler threads have completed their work, then the sampler threads go into a blocked state waiting for new work to be assigned.

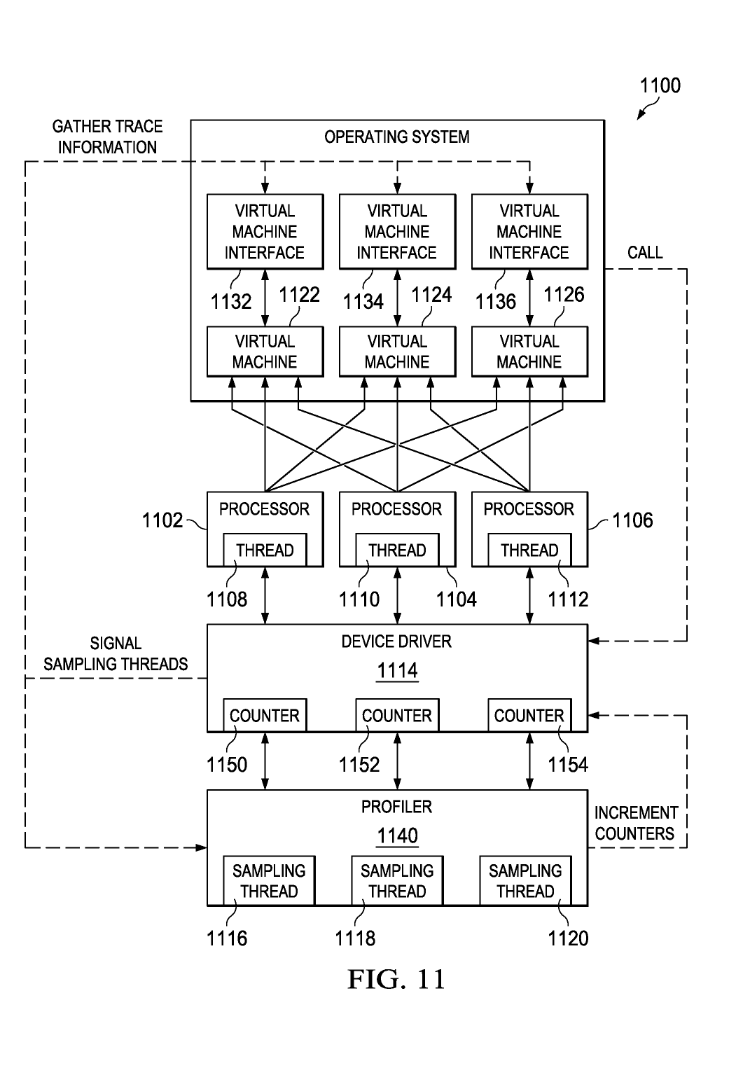

FIG. 11 is an example block diagram of a system for performing profiling of a computer program with regard to multiple threads executed by multiple processors in conjunction with multiple virtual machines in accordance with one illustrative embodiment. As shown in FIG. 11, each sampling thread 1116-1120 is associated with a corresponding thread 1108-1112 executing on one of the processors 1102-1106 of the data processing system 1 100. These executing threads 1108-1112 may access one or more virtual machines 1122-1126 of the data processing system 1100. Moreover, the sampling threads 1116-1120 may access the virtual machines 1122-1126 via corresponding virtual machine interfaces 1132-1136.

The profiler 1140 may operate in a similar manner as previously described to gather trace information, such as call stack information of each of the virtual machines 1122-1126 of interest using corresponding sampling threads 1116-1120. The profiler 1140 may generate one or more trace data files and call trees based on the trace information gathered from the sampling threads 1116-1120.

The device driver 1114, like the device driver 414 in FIG. 4, signals the sampling threads 1116-1120 to cause these sampling threads 1116-1120 to awaken and determine if gathering of trace information is to be performed. In addition, the device driver 1114 may maintain a plurality of sampling statistic counters 1150-1154 that are incremented based on the execution state of execution threads 1108-1112 each time that the sampling threads 1116-1120 are awakened. The profiler 1140 may access these counters 1150-1154 to obtain statistical information about the sampling of the execution of the threads 1108-1112 and use that statistical information in generating trace data files and reports.

As mentioned above, each time a sampling interrupt is generated by a processor 1102-1106, the interrupt is sent to an operating system which in turn generates a call to the device driver 1114. The device driver 1114 may signal the sampling threads 1116-1120 of the profiler 1140 to cause these sampling threads 1116-1112 to awaken. In response, each sampling thread 1116-1120 determines the state of their corresponding execution thread 1108-1112 and, based on this state, determines if trace information is to be gathered from the virtual machine being accessed by that execution thread or not. For example, the work areas of the respective sampling threads 1116-1120 may be written with an identifier of one or more virtual machines 1122-1126 of interest.

Not all virtual machines 1122-1126 of the data processing system need to be designated as virtual machines of interest. For example, in some cases only a single virtual machine 1122 may be of interest to the profiler 1140. While only one virtual machine 1122 may be of interest, each execution thread 1108-1112 may be able to access that same virtual machine 1122 or instances of the same virtual machine 1122 may be provided in association with multiple ones of the execution threads 1108-1112 such that multiple execution threads 1108-1112 may be executing in association with, or accessing, the same virtual machine 1122. In such a case, the mechanisms of the illustrative embodiments gather trace information for each of these execution threads but may aggregate this trace information or otherwise combine the trace information.

For each sampling thread 1116-1120 that has an associated executing thread 1108-1112 that is executing in a virtual machine 1122-1126 of interest at the time of the sampling, trace information, such as call stack information, is gathered and provided to the profiler 1140. For those sampling threads 1116-1120 that have associated executing threads 1108-1112 that are not executing in a virtual machine 1122-1126, such trace information is not gathered. Rather, if it is determined that at least one other sampling thread 1116-1120 is to gather trace information, then the sampling threads not executing in a virtual machine 1122-1126 of interest may be placed in a spin or loop state until the other sampling thread(s) finish gathering their trace information.

In either case, or if neither of these cases occur, the device driver 1114 may update statistical counters 1150-1154 based on a determined condition of the execution threads 1108-1112. The particular conditions associated with the statistical counters 1150-1154 may be of various types. For example, one statistical counter 1150 may be associated with a garbage collection condition in which, if a sampling thread 1116-1120 determines that its corresponding execution thread 1108-1112 is involved in a garbage collection operation, then the statistical counter 1150 is incremented. As a further example, another statistical counter 1152 may be associated with a condition in which the execution thread is simply determined to be executing a process outside a virtual machine of interest and may be incremented in response to sampling threads 1116-1120 determining that their corresponding executing threads 1108-1112 are executing outside of a virtual machine of interest.

As still another example, a third statistical counter 1156 may be associated with a condition in which an executing thread is executing within a virtual machine of interest. Thus, when the sampling thread 1116-1120 determines that its corresponding execution thread is executing within the virtual machine 1122-1126 of interest, the counter 1156 may be incremented by the device driver 1114. It should be appreciated that other counters associated with other types of execution conditions of executing threads 1108-1112 may be used in addition to, or in replacement of, the counters 1152-1156 without departing from the spirit and scope of the illustrative embodiments.

The profiler 1124, when generating a report, may access these counters 1152-1156 and use them to provide execution statistics in the reports. For example, the count value of counter 1152 may provide information regarding the relative amount of time that threads spend executing garbage collection operations. The count value of the counter 1154 may provide information regarding the relative amount of time that threads spend executing processes outside of virtual machines of interest. Moreover, the count value of the counter 1156 may provide information regarding the relative amount of time that threads spend executing processes within virtual machines of interest.

Thus, depending upon the execution state of the execution threads 1108-1112 corresponding to the sampling threads 1116-1120, trace information may be gathered concurrently for one or more virtual machines 1122-1126 of interest of the data processing system. As a result, more accurate trace information may be gathered in a more efficient and timely manner than the serial manner of known profiling tools. Moreover, the trace information may be gathered for each executing thread that is executing within a virtual machine of interest regardless of whether that thread was the one generating the original interrupt or not. Statistical counters may be used to generate information about the state of executing threads regardless of whether the executing threads are the ones that generated an original interrupt or not. These statistical counters can provide insight into the time spent in various portions of the data processing system's execution environments by the executing threads.

Reports may be generated by the profiler based on this trace information and statistical counter information. These reports may provide information about the call stack, statistical measures regarding time spent in particular portions of code, and the like. The trace reports may take many different forms depending upon the particular implementation of the illustrative embodiments. Such reports may be subject to further processing, such as by a post processor or the like, to generate other reports for identifying portions of the code that may be candidates for optimization, may have areas where correction of the code is necessary or desirable, or the like.

It should be appreciated that, in one illustrative embodiment, the trace information gathered using the mechanisms of the illustrative embodiments may be stored in trace and/or report data files that may be stored for later use. A separate run and trace of the computer code may be performed to generate second trace information and second trace and/or report data files. These separate runs and traces of the computer code may then be provided to a post processor which compares the traces to identify portions of computer code where there are problems requiring correction or where computer code may be tuned or optimized for better performance. Such comparison and analysis may be performed automatically by the post processor based on rules that identify specific characteristics or conditions meeting predefined criteria indicating that a problem or area where tuning may or should be performed.

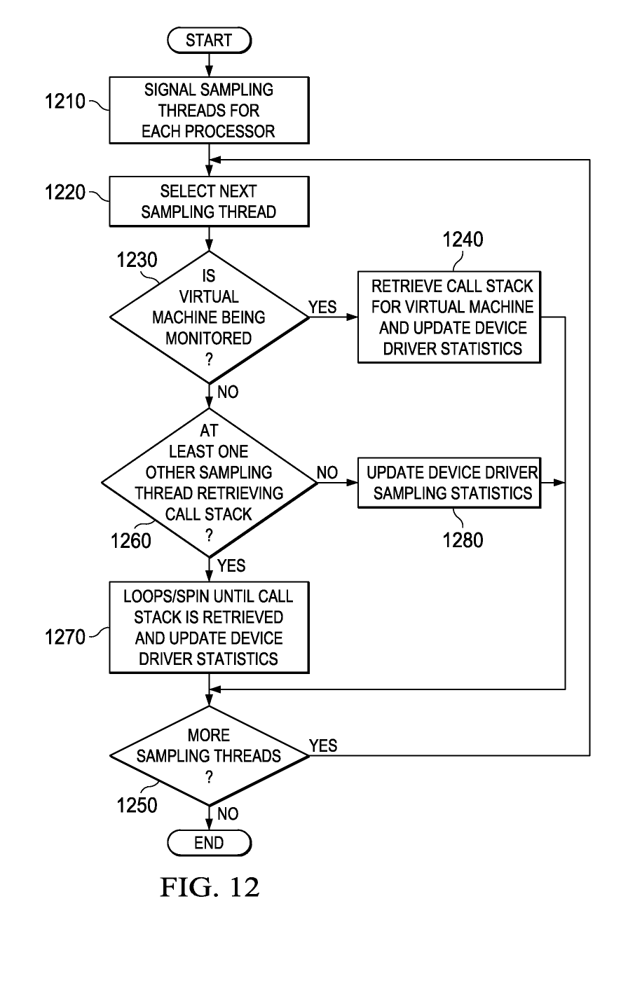

FIG. 12 is a flowchart outlining an example operation of sampling thread in accordance with an illustrative embodiment in which multiple threads of multiple processors and multiple virtual machines are profiled. FIG. 12 is shown as executing for each sampling thread in series however it should be appreciated that such determinations of state of execution threads may be performed in parallel rather than in series.

As shown in FIG. 12, the operation starts by the device driver signaling each of the sampler threads for each of the processors of the data processing system (step 1210). A next sampler thread is selected (step 1220) and a determination is made as to whether the corresponding executing thread of the selected sampler thread is executing in a virtual machine of interest at the time of the sampling (step 1230). If the execution thread was executing in a virtual machine of interest, then the call stack information for the virtual machine is retrieved and device driver statistics, such as in the statistical counters, are updated (step 1240). A determination is then made as to whether there are more sampling threads to process (step 1250). If so, the operation returns to step 1120 otherwise the operation terminates.

If the execution thread is not executing in the virtual machine of interest, a determination is made as to whether there are any other sampling threads that need to retrieve trace information (e.g., call stack information) from a virtual machine (step 1260). If so, the current sampling thread is placed in a loop/spin state until the calls tack is retrieved by the other sampling thread(s). In addition, device driver statistics are updated (step 1270). If at least one other sampling thread does not need to retrieve call stack information, then the device driver statistics may simply be updated (step 1280).

Thus, the illustrative embodiments provide mechanisms for time-based context sampling with support for multiple virtual machines. As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for performing time-based context sampling for profiling an execution of computer code in the data processing system, the method comprising:
in response to the occurrence of an event, waking a plurality of sampling threads associated with a plurality of executing threads executing on processors of the data processing system;
determining, by a processor of the data processing system, for each sampling thread, an execution state of a corresponding executing thread with regard to one or more virtual machines of interest;
determining, by the processor, for each sampling thread, based on the execution state of the corresponding executing thread, whether to retrieve trace information from a virtual machine associated with the corresponding executing thread; and
for each sampling thread, in response to a determination that trace information is to be retrieved from a virtual machine associated with the corresponding executing thread, retrieving the trace information from the virtual machine and storing the trace information in a storage device associated with the data processing system.

2. The method of claim 1, wherein determining, for each sampling thread, whether to retrieve trace information from a virtual machine associated with the corresponding executing thread comprises:
determining if any of the sampling threads are to retrieve trace information from a virtual machine associated with the corresponding executing thread; and
in response to a determination that none of the sampling threads are to retrieve trace information, updating one or more device driver sampling statistics counters associated with the plurality of executing threads based on conditions of execution of the corresponding executing threads.

3. The method of claim 1, further comprising:
selecting a virtual machine of interest for which trace information is to be gathered from threads executing in the virtual machine of interest on the processors of the data processing system, wherein:
determining, for each sampling thread, whether to retrieve trace information from a virtual machine associated with the corresponding executing thread comprises determining if the corresponding execution thread is presently executing in the virtual machine of interest, and
trace information is retrieved from the virtual machine associated with the corresponding executing thread in response to the virtual machine being the virtual machine of interest.

4. The method of claim 3, wherein if the executing thread corresponding to a current sampling thread is not presently executing in a virtual machine of interest, but there is at least one other sampling thread having a corresponding executing thread executing in a virtual machine of interest, then the current sampling thread is placed in a spin state until trace information is gathered by the at least one other sampling thread.

5. The method of claim 1, further comprising:
updating one or more sampling statistical counters associated with the plurality of executing threads based on conditions of execution of the corresponding executing threads.

6. The method of claim 5, wherein the one or more sampling statistical counter comprises at least one of a first counter for counting a number of times a sampling thread determines that its corresponding executing thread is involved in a garbage collection operation when the sampling thread is awoken, a second counter for counting a number of times that a sampling thread determines that its corresponding executing thread is executing a process outside a virtual machine of interest when the sampling thread is awoken, or a third counter for counting a number of times a sampling thread determines that its corresponding executing thread is executing within a virtual machine of interest when the sampling thread is awoken.

7. The method of claim 3, wherein selecting a virtual machine of interest comprises:
registering a plurality of virtual machines with a profiler tool executing in the data processing system; and
receiving a selection of a virtual machine in the plurality of virtual machines registered with the profiler tool as a virtual machine of interest.

8. The method of claim 7, wherein the profiler tool selects a virtual machine of interest from the plurality of virtual machines by selecting a next virtual machine in a cycling through a subset of the plurality of virtual machines registered with the profiler tool.

9. The method of claim 7, wherein the selected virtual machine of interest is part of a subset of the plurality of virtual machines registered with the profiler tool are selected for gathering of trace information, and wherein the subset of the plurality of virtual machines is less than a total number of the plurality of virtual machines registered with the profiler tool.

10. The method of claim 3, wherein work areas of memory corresponding to the sampling threads are written with an identifier of the selected virtual machine of interest.

11. A computer program product comprising a computer recordable medium having a computer readable program recorded thereon, wherein the computer readable program, when executed on a computing device, causes the computing device to:
wake, in response to the occurrence of an event, a plurality of sampling threads associated with a plurality of executing threads;
determine for each sampling thread, an execution state of a corresponding executing thread with regard to one or more virtual machines of interest;
determine for each sampling thread, based on the execution state of the corresponding executing thread, whether to retrieve trace information from a virtual machine associated with the corresponding executing thread; and
for each sampling thread, in response to a determination that trace information is to be retrieved from a virtual machine associated with the corresponding executing thread, retrieve the trace information from the virtual machine and storing the trace information in a storage device associated with the computing device.

12. The computer program product of claim 11, wherein the computer readable program causes the computing device to determine, for each sampling thread, whether to retrieve trace information from a virtual machine associated with the corresponding executing thread by:
determining if any of the sampling threads are to retrieve trace information from a virtual machine associated with the corresponding executing thread; and
in response to a determination that none of the sampling threads are to retrieve trace information, updating one or more device driver sampling statistics counters associated with the plurality of executing threads based on conditions of execution of the corresponding executing threads.

13. The computer program product of claim 11, wherein the computer readable program further causes the computing device to:
select a virtual machine of interest for which trace information is to be gathered from threads executing in the virtual machine of interest on the processors of the data processing system, wherein:
determining, for each sampling thread, whether to retrieve trace information from a virtual machine associated with the corresponding executing thread comprises determining if the corresponding execution thread is presently executing in the virtual machine of interest, and
trace information is retrieved from the virtual machine associated with the corresponding executing thread in response to the virtual machine being the virtual machine of interest.

14. The computer program product of claim 13, wherein if the executing thread corresponding to a current sampling thread is not presently executing in a virtual machine of interest, but there is at least one other sampling thread having a corresponding executing thread executing in a virtual machine of interest, then the current sampling thread is placed in a spin state until trace information is gathered by the at least one other sampling thread.

15. The computer program product of claim 11, wherein the computer readable program further causes the computing device to:
update one or more sampling statistical counters associated with the plurality of executing threads based on conditions of execution of the corresponding executing threads.

16. The computer program product of claim 15, wherein the one or more sampling statistical counter comprises at least one of a first counter for counting a number of times a sampling thread determines that its corresponding executing thread is involved in a garbage collection operation when the sampling thread is awoken, a second counter for counting a number of times that a sampling thread determines that its corresponding executing thread is executing a process outside a virtual machine of interest when the sampling thread is awoken, or a third counter for counting a number of times a sampling thread determines that its corresponding executing thread is executing within a virtual machine of interest when the sampling thread is awoken.

17. The computer program product of claim 13, wherein the computer readable program causes the computing device to select a virtual machine of interest by:
registering a plurality of virtual machines with a profiler tool executing in the data processing system; and
receiving a selection of a virtual machine in the plurality of virtual machines registered with the profiler tool as a virtual machine of interest.

18. The computer program product of claim 17, wherein the profiler tool selects a virtual machine of interest from the plurality of virtual machines by selecting a next virtual machine in a cycling through a subset of the plurality of virtual machines registered with the profiler tool.

19. The computer program product of claim 17, wherein the selected virtual machine of interest is part of a subset of the plurality of virtual machines registered with the profiler tool are selected for gathering of trace information, and wherein the subset of the plurality of virtual machines is less than a total number of the plurality of virtual machines registered with the profiler tool.

20. An apparatus, comprising:
a processor; and
a memory coupled to the processor, wherein the memory comprises instructions which, when executed by the processor, cause the processor to:
wake, in response to the occurrence of an event, a plurality of sampling threads associated with a plurality of executing threads;
determine for each sampling thread, an execution state of a corresponding executing thread with regard to one or more virtual machines of interest;
determine for each sampling thread, based on the execution state of the corresponding executing thread, whether to retrieve trace information from a virtual machine associated with the corresponding executing thread; and
for each sampling thread, in response to a determination that trace information is to be retrieved from a virtual machine associated with the corresponding executing thread, retrieve the trace information from the virtual machine and storing the trace information in a storage device associated with the computing device.
